(19) United States
(12) Patent Application Publication
(10) Pub. No.: US 2007/0018054 A1
(43) Pub. Date: Jan. 25, 2007

(54) System and method for reducing the loads acting on the fuselage structure in means of transport

(76) Inventors: Michael Enzinger, Neu Wulmstorf (DE); Michael Kordt, Hamburg (DE)

Correspondence Address: OSTROLENK FABER GERB & SOFFEN, 1180 AVENUE OF THE AMERICAS, NEW YORK, NY, 100368403, US

(21) Appl. No.: 11/154,916

(22) Filed: Jun. 16, 2005

Related U.S. Application Data
(60) Provisional application No. 60/606,665, filed on Sep. 2, 2004.

(30) Foreign Application Priority Data
Jun. 16, 2004 (DE) 102004029196.9

(51) Int. Cl. G05D 1/00

(52) U.S. Cl. 244/195

(57) ABSTRACT

The invention relates to a system for reducing the loads acting on the fuselage structure in means of transport, in particular in aircraft, comprising at least one sensor means 6, at least one actuator, and at least one control unit 11.

According to the invention, an amplitude characteristic and/or phase characteristic of loads acting on the fuselage structure are/is modifiable such that a reduction in the load acting on a fuselage structure 5 of a means of transport occurs, as a result of which a significant reduction in the loads acting on the fuselage structure of a means of transport is possible in a particular frequency interval.

Furthermore, the invention relates to a method for reducing the loads acting on the fuselage structure in means of transport, in particular in aircraft, comprising at least one sensor means 6, at least one actuator, and at least one control unit 11.

According to the method of the invention, an amplitude characteristic and/or phase characteristic of loads acting on the fuselage structure are/is modified such that a reduction in the load acting on a fuselage structure 5 of a means of transport occurs, as a result of which a significant reduction in the loads acting on the fuselage structure of a means of transport in a particular frequency range is possible.

The invention relates to a system for reducing the loads acting on the fuselage structure in means of transport, in particular in aircraft, comprising at least one sensor means, at least one actuator, and at least one control unit.

Furthermore, the invention relates to a method for reducing the loads acting on the fuselage structure in means of transport, in particular in aircraft, comprising at least one sensor means, at least one actuator, and at least one control unit.

By means of the system according to the invention and/or the method according to the invention, dynamic fuselage structure design loads (hereinafter abbreviated to “loads acting on the fuselage structure”), which are induced into the fuselage structure for example by gusts, turbulence or flight manoeuvres, are reduced with the use of sensor means for registering the fuselage movement, and with the use of at least one control unit for modification of the signals provided by the sensor means, of at least one control-, tail- or regulating surface, as well as by means of at least one actuator which interacts with the control-, tail- or regulating surfaces.

Fuselage structure loads and thus the structural design and structural weight of large flexible aircraft as well as of aircraft with long fore and aft fuselage sections result from the aircraft's dynamic response to gusts and manoeuvres, i.e. to the forces resulting from these.

From the state of the art, modal-type suppression systems or oscillation type suppression systems for aircraft are known, which suppression systems attenuate selected elastic fuselage bending types of oscillation or bending of intrinsic fuselage shapes caused by gusts. These suppression systems are based on control systems using control-, tail- or regulating surfaces. They are used for attenuating one or several selected intrinsic shapes of fuselage bending caused by gusts. Furthermore, devices for wing load reduction are known from the state of the art. The known devices or methods are thus not used for reducing structural loads acting on the fuselage structure.

In order to optimally reduce such loads acting on the fuselage structure, it is necessary at the same time to modify intrinsic shapes of the rigid body movement, for example intrinsic shapes of the tumbling motion or intrinsic shapes of the rigid body movement (hereinafter in brief referred to as “intrinsic shape of the rigid body”) and elastic intrinsic shapes of fuselage movement or types of fuselage oscillation (hereinafter in brief referred to as “intrinsic fuselage shape”).

Furthermore, simple attenuation of elastic intrinsic fuselage shapes represents only a very specific modification of the amplitude characteristics and phase characteristics of an intrinsic shape. Any efficient reduction in structural loads therefore necessitates further-reaching modifications of the amplitude position and phase position of the loads acting on the fuselage structure.

Consequently, for reducing the loads acting on the fuselage structure it is not sufficient to simply modify the amplitude characteristics and phase characteristics in the region of the elastic intrinsic shapes and of the intrinsic shapes of the rigid body. Instead it is necessary to also modify the frequency range between intrinsic shapes of the rigid body and elastic intrinsic shapes, and between adjacent elastic intrinsic shapes in such a way that the loads acting on the fuselage structure are reduced as far as possible. This means that an optimal reduction in the loads acting on the fuselage structure requires general modification of the frequency range of the intrinsic shapes of the rigid body and of the essential elastic intrinsic shapes of the fuselage. In many aircraft this relevant frequency range is between 0 and 10 Hz. The upper limit of this frequency range is limited to approximately 10 Hz by the maximum regulating speed of the actuators or of the tail-, control- and regulating surfaces.

It is the object of the invention to provide a system and a method which make it possible to significantly reduce the loads acting on the fuselage structure of a means of transport, in particular an aircraft, in a particular frequency range.

This object is met by a system with the characteristics of claim 1.

A significant reduction in the loads acting on the fuselage structure of a means of transport in a particular frequency interval is possible in that amplitude characteristics and/or phase characteristics of structural loads acting on the fuselage can be modified such that a reduction in the load acting on a fuselage structure of a means of transport results. This makes it possible to meet strength specifications which it would be impossible to meet without applying the method. Furthermore, increased comfort in means of transport can be achieved by the system.

Furthermore, this object is met by a method with the characteristics of claim 10.

A significant reduction in the loads acting on the fuselage structure of a means of transport in a particular frequency interval is possible in that amplitude characteristics and/or phase characteristics of structural loads acting on the fuselage are modified such that a reduction in the load acting on a fuselage structure of a means of transport results. This makes it possible to meet strength specifications which it would be impossible to meet without applying the method. Furthermore, increased comfort in means of transport can be achieved by the system.

According to the invention, the loads acting on the fuselage structure are reduced by means of actuators which act upon the control-, tail- and/or regulating surfaces of the means of transport, in particular of an aircraft. The control-, tail- and/or regulating surfaces are in particular ailerons and rudder if the system according to the invention or the method according to the invention is used in an aircraft. In an alternative embodiment, at least one actuator directly acts on the fuselage structure of the means of transport so as to reduce the loads acting on the fuselage structure. A reduction in the loads acting on the fuselage structure is achieved by modifying the forces and movements impinging on the fuselage structure which are caused by the correspondingly controlled control-, tail- and/or regulating surfaces, i.e. the actuators acting directly on the fuselage structure. The control-, tail- and/or regulating surfaces influenced by the actuators, as well as any actuators which act directly on the fuselage structure can be combined in any desired way both in relation to the way they interact between or among each other, and in relation to their number.

Controlling or regulating the actuators takes place depending on measuring signals acquired with sensor means, which measuring signals after conversion to a controlled quantity within a control unit are modified by filter elements and the like to form a regulated quantity, wherein the controlled quantity modified in this way is conveyed to the actuators by way of an amplification factor unit and as a result of this is fed back to the fuselage structure. The control signal/s present at the actuators represents/represent a regulated quantity. The actuators can act on the fuselage structure directly and/or indirectly by way of control-, tail- and/or regulating surfaces so as to reduce the loads acting on the fuselage structure of the means of transport.

Control by the system according to the invention or the method according to the invention is effective in parts or in the entire frequency range of the intrinsic shapes of the rigid body and/or of the elastic intrinsic shapes of the fuselage structure; it covers for example a frequency range of between 0 Hz and 10 Hz.

The invention provides a particular advantage in that it clearly reduces the loads acting on the fuselage structure, which loads can for example be caused by gusts and/or flight manoeuvres, by a drastic modification of the movements in the fuselage structure and of the mechanical forces acting on said fuselage structure in a particular frequency interval.

The effectiveness of the system according to the invention and the number of the available design parameters (for example the sensor means to be selected, the control-, tail- and/or regulating surfaces to be determined, the actuators, the selection and the design of a suitable control unit) are varied so that advantageously the critical frequency range can be precisely determined according to the loads acting on the fuselage structure, which loads are to be reduced. This must not bring about any impairment in the aircraft design or in the integrity of said aircraft design.

Further advantageous embodiments of the device are stated in further claims.

The following are shown in the drawing:

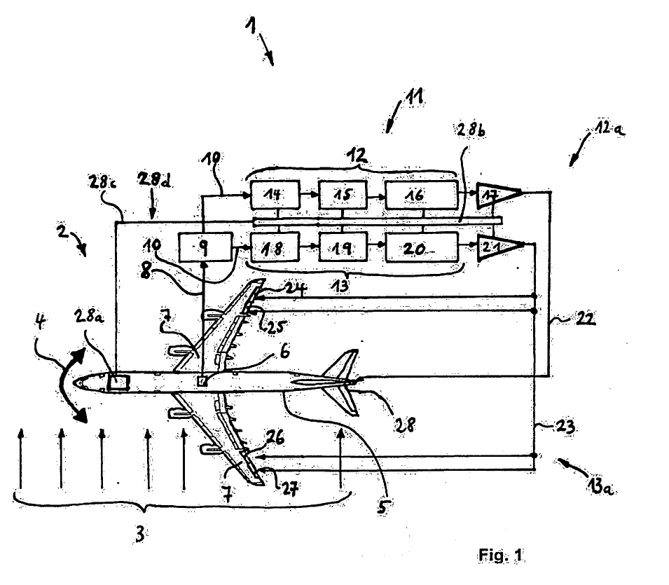

FIG. 1 An exemplary representation of a system for reducing the loads acting on the fuselage structure of an aircraft in the case of lateral loads acting on the fuselage structure;

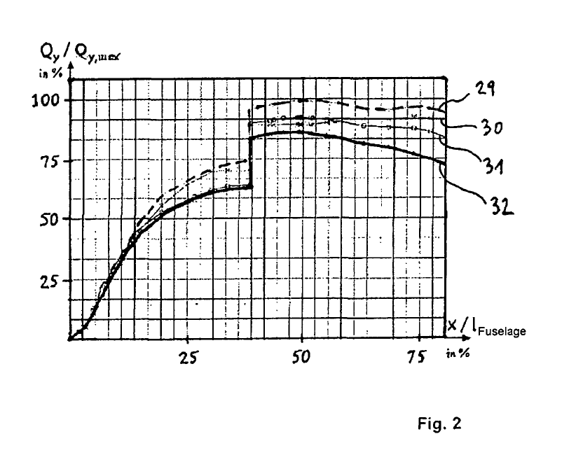

FIG. 2 Transverse forces Q_{Y} in a fuselage structure of an aircraft with and without the use of the system in three different versions for reducing the loads acting on the fuselage structure;

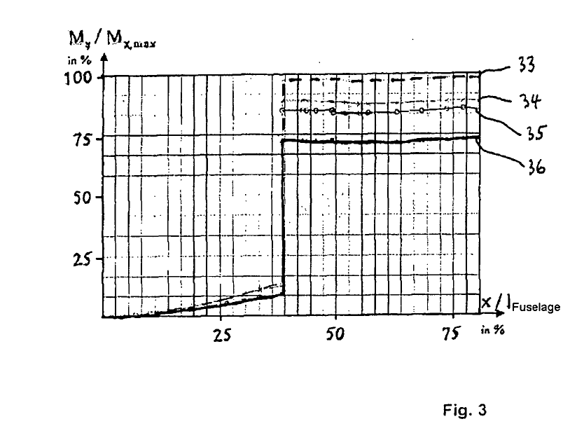

FIG. 3 Bending moment M_{X} in a fuselage structure of an aircraft with and without the use of the system for reducing the loads acting on the fuselage structure; and

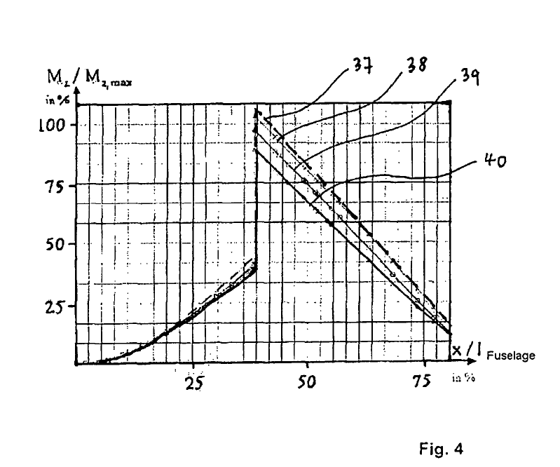

FIG. 4 Torsional moment M_{Z} in a fuselage structure of an aircraft with and without the use of the system for reducing the loads acting on the fuselage structure.

FIG. 1 shows a diagrammatic embodiment of the system 1 according to the invention, for reducing the load acting on the fuselage.

An aircraft 2 essentially encounters gusts 3 transversely to its longitudinal direction. This results in loads (indicated by a double arrow 4) acting on the fuselage structure 5 of the aircraft 2. The loads acting on the fuselage structure are thus essentially caused by gusts 3. However, such loads acting on the fuselage structure can also be induced into the fuselage structure 5 by respective flight manoeuvres of the aircraft 2.

FIG. 1 predominantly illustrates the reduction in lateral loads acting on the fuselage structure by means of the system 1 according to the invention, which loads are caused in the fuselage structure 5 by gusts 3. Beyond this, the system 1 according to the invention is equally suited to reducing vertical loads (not shown) acting on the fuselage structure, and/or to reducing flight-manoeuvre-induced loads (also not shown) acting on the fuselage structure.

In the embodiment shown, a sensor means 6 is positioned in the area where the wings 7 are attached to the fuselage structure 5. Preferably, the sensor means 6 is positioned in a location where it can register as well as possible the loads acting on the fuselage structure, either directly or at least by way of the movements or forces caused by said loads. It is particularly advantageous if the sensor means 6 is arranged in a region of the fuselage structure 5 in which the highest loads acting on the fuselage structure occur.

The sensor means 6 can for example be a strain gauge or extensometer, an optical sensor, Bragg sensor, acceleration sensor, speed sensor or the like. Furthermore, the use of several sensor means 6 using identical and/or different technologies in various locations of the fuselage structure 5 of the aircraft 2 is possible.

A measuring signal 8 supplied by the sensor means 6 is first conveyed to a signal processing unit 9, which can for example comprise an anti-aliasing filter, a signal amplifier for changing the amplitude etc. The sensor means 6 converts any movement in the fuselage structure 5 and/or converts the forces acting on the fuselage structure 5 into the measuring signal 8 which thus contains all essential information about the loads acting on the fuselage structure.

From the signal processing unit 9 the measuring signal 8 reaches the control unit 11 as a controlled quantity 10. At the control unit 11, corresponding modification takes place by way of filter means and the like for reducing the loads acting on the fuselage structure. For this purpose, in the embodiment shown in FIG. 1, the control unit 10 comprises two control lines 12, 13, arranged in parallel. The control line 12 comprises a low-pass filter 14, a high-pass filter 15, a phase correction unit 16 as well as an amplification factor unit 17 connected in series. Correspondingly, the control line 13 comprises a low-pass filter 18, a high-pass filter 19, a phase correction unit 20 as well as an amplification factor unit 21 connected in series.

The low-pass filters 14, 18 are used to remove higher-frequency fractions from the controlled quantity 10. The low-pass filters thus let those signals pass whose frequencies correspond to the frequencies of at least one intrinsic shape of the rigid body and/or of an elastic intrinsic shape. Correspondingly, the high-pass filters 15, 19 are used to remove low-frequency fractions from the controlled quantity 10. The amplification factor units 17, 21 are used to amplify and to form two regulated quantities 22, 23 which by way of actuators (not shown in detail in FIG. 1) act upon the ailerons 24, 25, 26, 27 as well as on the rudder 28 of the aircraft 2. By means of the phase correction units 16, 20, phase correction of the controlled quantity 10 becomes possible, i.e. a time shift becomes possible in the controlled quantity 10 to compensate further system-imminent delays.

In an alternative embodiment (not shown in FIG. 1) of the system according to the invention it is possible that, additionally or exclusively, actuators are provided which act directly on the fuselage structure 5 of the aircraft 2. These actuators can be piezoelectric actuators, or they can for example be hydraulic cylinders whose abutments and piston rods are connected in a non-positive way to the fuselage structure.

The control unit 11 comprises an amplification factor a which is used for setting the amplitude of the loads acting on the fuselage structure or of the controlled quantity 10, which represents said loads acting on the fuselage structure. Setting the amplification factor a can for example take place in the signal processing unit 9 by means of the signal amplifier (not shown in detail) or by means of some other functional unit.

The low-pass filters 14, 18 are parameterised low-pass filters of the first order with f_{low-pass}(s)=1/(s+b) or a higher-order low-pass filter. In this arrangement, the cut-off frequency up to which the low-pass filter allows signals to pass is determined by the parameter b. The high-pass filters 15, 19 as well as the phase correction units 16, 20 are not obligatory for proper functioning of the device according to the invention, however, they can further enhance its effectiveness.

The control unit 11 thus acts evenly in the frequency range from 0 Hz to the cut-off frequency determined by the parameter b. Normally—due to regulating rate limitations of the actuators, of the ailerons and the rudder 24, 25, 26, 27, 28, as well as due to system-imminent delays—the technically relevant frequency range is approximately 0 Hz to 10 Hz. By selecting the parameter b, the frequency range of the loads acting on the fuselage structure, which frequency range is to be modified, is determined, while the parameter a only modifies the amplitude characteristics.

The control unit 11 can thus also be integrated into known flight-mechanics controllers if the flight-mechanics controller also has a low-pass, and if identical sensor means 6 are used for the flight-mechanics controller and for the system for reducing the loads acting on the fuselage structure. In this case the cut-off frequency of a low-pass contained in the flight mechanics controller would have to be selected so as to be the same as the cut-off frequency of the low-pass filter units 14, 18. In this case the measuring signals of yaw rate sensors, speed sensors, acceleration sensors or the like, which sensors are for example already present in the aircraft as part of a flight-mechanics controller, can in this case act as sensor means 6 or measuring signals 8. In such an arrangement, it would essentially only be the intrinsic shapes of the rigid body—such as the tumbling oscillation and, depending on the controller, the low-frequency elastic intrinsic shapes relevant from the point of view of flight mechanics, as well as the frequency range between these intrinsic shapes—that would be influenced.

As shown in FIG. 1, the control unit 11 further comprises the phase correction units 16, 20. The frequency behaviour of the phase correction units 16, 20 is defined according to the relation f_{Phase}(s)=−c*s+1/(c*s+1) with the parameter c to be selected freely. In contrast to parameter a, parameter c does not influence the amplitude, but only influences the phase of the loads acting on the fuselage structure or of the control quantities 10 representing said loads.

If the dynamic behaviour of the aircraft 2 in regard to stability, aeroelasticity, comfort, flight mechanics and flight characteristics turns out to be insufficient if only the control unit 11 configured with the parameters a, b is used, the above results in further options of reducing the loads acting on the fuselage structure 5 as a result of the further adjustment option using the additional parameter c.

The high-pass filters 15, 19, which are also shown in FIG. 1, make it possible to use further-reaching filter structures which allow targeted amplitude modification in a particular subinterval of the frequency range under consideration, namely from 0 Hz to 10 Hz. In each case, the cut-off frequencies of the high-pass filters 15, 19 are to be determined by way of a further parameter d. Determining said cut-off frequencies takes place analogously to the procedure for determining the parameter b, as explained in the context of the description of parameterising the low-pass filters 14, 18.

Due to the shown combination of low-pass filters, high-pass filters, as well as of phase correction units and amplification factor units 14 to 21, efficient reduction in the loads acting on the fuselage structure is possible. If several frequency ranges of loads acting on the fuselage structure are to be modified using the system according to the invention, several such filter combinations have to be connected in parallel, as is the case in the embodiment shown in FIG. 1. A control branch 12a comprises the sensor means 6, the signal processing unit 9, low-pass filter 14, high-pass filter 15, phase correction unit 16, amplification unit 17 as well as the rudder 28. A control branch 13a comprises the sensor means 6, the signal processing unit 9, low-pass filter 18, high-pass filter 19, phase correction unit 20, amplification factor unit 21, as well as the ailerons 24, 25, 26, 27. When such control branches 12a, 13a are connected in parallel, each control branch can comprise a different sensor means 6, a different actuator and/or different control-, tail- and/or regulating surfaces.

Since the loads acting on the fuselage structure greatly change as the position of the centre of gravity or the quantity of fuel in the trimming tank of the aircraft 2 changes, and because the position of the centre of gravity due to fuel consumption usually changes only very slowly, the design parameters a, b, c, d of each control branch 12a, 13a can be adjusted in real time to the current position of the centre of gravity or the quantity of fuel in the trimming tank or the precise weight distribution in the fuselage of the aircraft 2. This requires a computer unit 28a which transmits corresponding signal information 28d—including information on the position of the centre of gravity, the quantity of fuel in the trimming tank, or the weight distribution in the fuselage—to an adjustment unit 28b by way of a line 28c. The adjustment unit 28b then adjusts the parameters a, b, c, d according to this signal information 28d.

In a further embodiment (not shown) of the system according to the invention, additional sensor means 6 and further tail surfaces, control surfaces or regulating surfaces and/or further actuators which act directly on the fuselage structure 5 can be provided. In this way, the system can use further feedback with additional high-pass filters, low-pass filters, phase correction units as well as amplification factor units.

In order to determine the parameters a, b, c, d, in the development phase the system requires explicit load criteria of the aircraft 2, which criteria specify that at a particular position in the fuselage structure the loads are reduced as far as possible, or are reduced to below or precisely to a particular threshold value or limiting value. The respective parameters are then to be selected such that the fuselage structure load criteria are met and the loads acting on other components, and the dynamic characteristics of the aircraft (stability, aeroelasticity, comfort, flight mechanics and flight characteristics) are maintained or change only within acceptable values.

FIG. 2 shows transverse forces Q_{y} in a fuselage structure of an aircraft with and without the use of the system 1 according to the invention for reducing the loads acting on the fuselage structure.

At a position x/I_{fuselage}—wherein in each case position x relates to the entire length of the fuselage I_{fuselage}—the vertical axis shows the transverse forces Q_{y}/Q_{y, max} acting on the fuselage structure 5, in each case relating to a maximum transverse force Q_{y, max}. The transverse forces Q_{y}/Q_{y, max} result from a load of the aircraft 2 as a result of lateral gusts 3 acting on the fuselage structure 5 (compare FIG. 1).

The curve shape 29 corresponds to the transverse forces experienced without the system 1 according to the invention for reducing the loads acting on the fuselage structure. In comparison, the curve shapes 30, 31 and 32 show the significant reduction of the transverse forces Q_{y}/Q_{y, max} achieved by means of the system 1 according to the invention along the entire length of the fuselage I_{fuselage}. The differences between the curve shapes 30, 31 and 32 result from a different configuration of the control unit 11 within the system 1. Corresponding modification of the parameters a, b, c, d within the control unit 11—as explained above in the context of the description of FIG. 1—in particular results in a multitude of variation options and optimisation options.

The point of discontinuity in all curve shapes 29, 30, 31, 32 at approximately 37.5% of the fuselage roughly corresponds to the local area in which the wings 7 are connected to the fuselage structure 5 of the aircraft 2.

The diagram shown in FIG. 3 essentially corresponds to the graphical representation of FIG. 2, except that, in a way that is different from the diagram of FIG. 2, the vertical axis shows the bending moments Mₓ/M_{x, max} of the fuselage structure 5 of the aircraft 2, which bending moments occur at a position x/I_{fuselage}—wherein in each case x relates to the entire length of the fuselage I_{fuselage}—in each case in relation to a maximum bending moment M_{x, max}. The bending moments Mₓ/M_{x, max} shown, in turn result from the aircraft 2 being exposed to loads due to gusts 3 acting laterally on the fuselage structure 5 (compare FIG. 1).

Again at approximately 37.5% of the fuselage length, i.e. essentially in the region where the wings 7 are attached, there is a point of discontinuity in the curve shape of the bending moments Mₓ/M_{x, max}. The curve shape 33 refers to the aircraft 2 without the system 1 according to the invention for reducing the loads acting on the fuselage structure, whereas curve shapes 34, 35 and 36 refer to the bending moment gradient Mₓ/M_{x, max} which results from the use of the system 1 according to the invention. Here again, the use of the system results in a significant reduction in the bending moments Mₓ/M_{x, max} at the respective positions x/I_{fuselage} of the fuselage structure 5. The differences among the curve shapes 34, 35, 36 are also due to a different configuration of the control unit 11 in the system 1. As far as further details are concerned, reference is thus made to the above explanations in conjunction with the description of FIG. 2.

The diagram shown in FIG. 4 essentially corresponds to the graphic representation in FIG. 3 wherein the vertical axis shows the torsional moments M_{z}/M_{z, max} which occur in the fuselage structure 5—wherein in each case x refers to the overall fuselage length I_{fuselage}—in each case in relation to a maximum bending moment M_{z, max}. The torsional moments M_{z}/M_{z, max} shown also result from the aircraft 2 being exposed to loads as a result of gusts 3 acting laterally on the fuselage structure 5 (compare FIG. 1).

The curve shape 37 corresponds to the gradient of the torsional moments M_{z}/M_{z, max} without the use of the system according to the invention, while the curve shapes 38, 39, 40 show the gradient of the torsional moments M_{z}/M_{z, max}, which gradient results from the use of the system 1 according to the invention. As shown in FIG. 4, the torsional moments M_{z}/M_{z, max} can also be significantly reduced using the system 1 according to the invention. As far as further details are concerned, reference is made to the description in the context of FIG. 2.

The curve shapes in the diagrams of FIGS. 2 to 4 relate to lateral loads in the fuselage structure 5. Comparable curve shapes result in relation to exposure of the fuselage structure 5 to vertical or combined lateral and vertical loads acting on said fuselage structure, and/or as a result of flight-manoeuvre-induced loads acting on the fuselage structure. Here again, a reduction in the load acting on the fuselage occurs as a result of the application of the system according to the invention, with correspondingly matched sensor means 6, actuators, control-, tail- and/or regulating surfaces.

In summary, the diagrams of FIGS. 2 to 4 show that all mechanical loads acting on the fuselage structure 5 of the aircraft 2 can be significantly reduced by the system 1 according to the invention.

When implementing the method according to the invention by means of the system 1 according to the invention as shown in FIG. 1, the sensor means 6 first registers the loads acting on the fuselage structure in the fuselage structure 5 of the aircraft 2, which loads are indicated by the double arrow 4. The loads acting on the fuselage structure are caused by the gusts 3 which essentially act laterally on the fuselage structure. FIG. 1 is limited to indicating lateral loads acting on the fuselage structure. However, the method according to the invention can also reduce vertical or combined vertical and lateral loads acting on the fuselage structure and/or reduce vertical, or combined vertical and lateral loads acting on the fuselage structure 5 for example induced by flight manoeuvres.

The measuring signal 8 provided by the sensor means 6, of which there is/are one or several, is subsequently conveyed to a signal processing unit 9. Within the signal processing unit 9, the measuring signal 8 is processed, for example by filtering and/or amplification. From the signal processing unit 9, the measuring signal which has been modified to form a controlled quantity 10 is conveyed to the control unit 11. The design of the control unit 11 corresponds to the design already explained in the context of the description of FIG. 1 so that in relation to further details concerning the control unit 11 reference is made to said description.

Within the control unit 11, the controlled quantity 10 is modified to form the regulated quantities 22, 23, and is fed back to the ailerons 24, 25, 26 and 27, as well as to the rudder 28, of the aircraft 2 by means of lines and actuators (not shown in detail in the drawing). Due to the feedback of the regulated quantities 22, 23 to the control-, tail- and/or regulating surfaces in the form of ailerons 24, 25, 26, 27, as well as of the rudder 28, of the aircraft 2, a closed control loop results.

By means of corresponding parameterisation of the control unit 11—wherein in relation to further details concerning the determination of the parameters in the control unit 11 reference is made to the description in the context of FIG. 1 above—the loads acting on the fuselage structure of the aircraft 2 in the frequency range of at least one intrinsic shape of the rigid body of the fuselage structure 5 and/or the loads acting on the fuselage structure in the frequency range of at least one elastic intrinsic shape of the fuselage structure 5 of the aircraft 2 are changed to such an extent that a significant reduction in the loads acting on the fuselage structure within the fuselage structure 5 of the aircraft 2 results.

The invention is not limited in any way to means of transport, in particular to aircraft. The invention can advantageously be applied in all large-volume and thus oscillateable spatial structures—for example ships, tall buildings, long bridges as well as large terrestrial vehicles etc.—for reducing loads acting on said structures.

### List of Reference Characters

1 System
2 Aircraft
3 Gusts
4 Double arrow
5 Fuselage structure
6 Sensor means
7 Wing
8 Measuring signal
9 Signal processing unit
10 Controlled quantity
11 Control unit
12 Control line
12a Control branch
13 Control line
13a Control branch
14 Low-pass filter
15 High-pass filter
16 Phase correction unit
17 Amplification factor unit
18 Low-pass filter
19 High-pass filter
20 Phase correction unit
21 Amplification factor unit
22 Regulated quantity
23 Regulated quantity
24 Aileron
25 Aileron
26 Aileron
27 Aileron
28 Rudder
28a Computer unit
28b Adjustment unit
28c Line
28d Signal information
29 Curve shape
30 Curve shape
31 Curve shape
32 Curve shape
33 Curve shape
34 Curve shape
35 Curve shape
36 Curve shape
37 Curve shape
38 Curve shape
39 Curve shape
40 Curve shape

1. A system for reducing the loads acting on the fuselage structure in means of transport, in particular in aircraft, comprising at least one sensor means (6), at least one actuator and at least one control unit (11), wherein amplitude characteristics and/or phase characteristics of loads acting on the fuselage structure can be modified such that a reduction in the load acting on a fuselage structure (5) of a means of transport results.

2. The system of claim 1, wherein by means of the sensor means (6), of which there is at least one, the loads acting on the fuselage structure are convertible to form at least one measuring signal (8) for forming at least one controlled quantity (10), wherein by means of the control unit (11) the controlled quantity (10) can be converted to form at least one regulated quantity (22, 23) such that feedback of the regulated quantity (22, 23) to the actuator or actuators results in modification of the amplitude characteristics and/or phase characteristics of the loads acting on the fuselage structure, as a result of which the reduction in the load acting on the fuselage structure (5) of the means of transport occurs.

3. The system of claim 1 or 2, wherein by means of the control unit (11) the loads acting on the fuselage structure in the frequency range of at least one intrinsic shape of the rigid body of the fuselage structure 5 and/or the loads acting on the fuselage structure in the frequency range of at least one elastic intrinsic shape of the fuselage structure (5) of the means of transport can be reduced.

4. The system of any one of claims 1 to 3, wherein the control unit (11) comprises at least one low-pass filter (14, 18) as well as an amplification factor unit (17, 21) arranged downstream of the low-pass filter (14, 18).

5. The system of any one of claims 1 to 4, wherein in each instance at least one phase correction unit (16, 20) is assigned to at least one low-pass filter (14, 18).

6. The system of any one of claims 1 to 5, wherein in each instance at least one high-pass filter (15, 19) is assigned to at least one low-pass filter (14, 18).

7. The system of any one of claims 1 to 6, wherein the actuator or actuators act on control-, tail-, and/or regulating surfaces of the means of transport, in particular on ailerons and the rudder (24-28).

8. The system of any one of claims 1 to 7, wherein the actuator or actuators act directly onto the fuselage structure (5).

9. The system of any one of claims 1 to 8, wherein a computer unit (28a) furnishes signal information (28d) concerning the position of the centre of gravity, the quantity of fuel in the trimming tank, and/or the fuselage weight distribution to an adjustment unit (28b) for adapting the control line or control lines 12, 13.

10. A method for reducing the loads acting on the fuselage structure in means of transport, in particular in aircraft, comprising at least one sensor means (6), at least one actuator and at least one control unit (11), wherein an amplitude characteristic and/or phase characteristic of loads acting on the fuselage structure are/is modified such that a reduction in the load acting on a fuselage structure (5) of a means of transport results.

11. The method of claim 10, wherein by means of the sensor means (6), of which there is at least one, the loads acting on the fuselage structure are converted to form at least one measuring signal (8) for forming at least one controlled quantity (10), wherein by means of the control unit (11) the controlled quantity (10) is converted to form at least one regulated quantity (22, 23), and the regulated quantity (22, 23) is fed back to the actuator or actuators, which results in modification of the amplitude characteristics and/or phase characteristics of the loads acting on the fuselage structure, which modification results in a reduction in the load acting on the fuselage structure (5) of the means of transport.

12. The method of claim 10 or 11, wherein by means of the control unit (11) the loads acting on the fuselage structure in the frequency range of at least one intrinsic shape of the rigid body and/or the loads acting on the fuselage structure in the frequency range of at least one elastic intrinsic shape of the fuselage structure (5) of the means of transport are reduced.

13. The method of any one of claims 10 to 12, wherein by means of at least one of the low-passes (14, 18) contained in the control unit (11), higher-frequency oscillation fractions from the controlled quantity (10), which fractions represent at least one of the intrinsic shapes of the rigid body of the fuselage structure (5), and/or represent at least one of the elastic intrinsic shapes of the fuselage structure (5) are modified.

14. The method of any one of claims 10 to 13, wherein by means of at least one phase correction unit (16, 20) assigned in each case to the low-pass (14, 18) or to the low-passes (14, 18), a phase correction of the controlled quantity (10) is carried out.

15. The method of any one of claims 10 to 14, wherein by means of at least on high-pass (15, 19) in each case assigned to the low-pass (14, 18) and/or the phase correction unit (16, 20), lower-frequency oscillation fractions of the controlled quantity (10) are modified.

16. The method of any one of claims 10 to 15, wherein by means of at least one amplification factor unit (17, 21) the regulated quantity (22, 23) is conveyed to at least one actuator, and the actuator or actuators act on the control-, tail- and/or regulating surfaces of the means of transport, in particular on the ailerons and the rudder (24-28).

17. The method of any one of claims 10 to 16, wherein the actuator or actuators directly act on the fuselage structure (5) of the means of transport.

18. The method of any one of claims 10 to 17, wherein signal information (28d) concerning the position of the centre of gravity, the quantity of fuel in the trimming tank, and/or the fuselage weight distribution is generated by means of a computer unit (28a) for adaptation of the control line or control lines 12, 13.
